(19) United States
(12) Patent Application Publication
(10) Pub. No.: US 2013/0341474 A1
(43) Pub. Date: Dec. 26, 2013

(54) GRIPPER WINDOW ROD

(71) Applicant: David Baines, Bedford, NY (US)

(72) Inventor: David Baines, Bedford, NY (US)

(73) Assignee: Maytex Mills, Inc., New York, NY (US)

(21) Appl. No.: 13/605,783

(22) Filed: Sep. 6, 2012

Related U.S. Application Data
(60) Provisional application No. 61/664,362, filed on Jun. 26, 2012.

(51) Int. Cl. A47H 1/14; A47H 1/142; E06B 7/28

(52) U.S. Cl. 248/208; 248/251; 248/231.91

(57) ABSTRACT

A window rod assembly includes a support rod extending between first and second arms, the support rod including first and second rod portions, wherein the first rod portion is configured to slideably engage the second rod portion; a fastener for maintaining a fixed spatial relationship between the first and second rod portions; a force adjuster positioned in one of the first and second rod portions; a first end bracket coupled to the first arm, the first end bracket including a first part configured to be positioned adjacent to a first interior surface of an opening; and a second end bracket coupled to the second arm, the second end bracket including a first part configured to be positioned adjacent to a second interior surface of the opening.

### CROSS-REFERENCE TO A RELATED APPLICATION

This application claims the benefit of U.S. Provisional Patent Application Ser. No. 61/664,362, filed Jun. 26, 2012, titled “Gripper Window Rod”, which is incorporated herein by reference.

### FIELD OF THE INVENTION

This invention relates to window rods.

### BACKGROUND

Conventional window curtain rods are mounted adjacent to a window by being screwed into the wall. The installation of window curtain rods can be time consuming. In addition to being tedious, it can be difficult to align the brackets. The installations are permanent and walls can be damaged in the process. For rental properties and student dorms, the damage caused by the screws is a significant issue and a deterrent to installation.

It would be desirable to have a window curtain rod that overcomes one or more of these deficiencies.

### SUMMARY

In a first aspect, a window rod assembly includes a support rod extending between first and second arms, wherein the support rod includes first and second rod portions, and the first rod portion is configured to slideably engage with the second rod portion; a fastener for maintaining a fixed spatial relationship between the first and second rod portions; a force adjuster positioned in one of the first and second rod portions; a first end bracket coupled to the first arm, the first end bracket including a first part configured to be positioned adjacent to a first interior surface of an opening; and a second end bracket coupled to the second arm, the second end bracket including a first part configured to be positioned adjacent to a second interior surface of the opening.

### BRIEF DESCRIPTION OF THE DRAWINGS

FIG. 1 shows a window rod assembly constructed in accordance with an embodiment of the invention.

FIG. 2 is a close up view of a fastener assembly for the window rod assembly of FIG. 1.

FIG. 3 is a side view of a force adjusting assembly that can be used in the window rod assembly of FIG. 1.

FIG. 4 is a schematic cross-sectional view of the force adjusting assembly of FIG. 3.

FIG. 5 is a close up view of one end bracket of the window rod assembly of FIG. 1.

FIG. 6 is a close up view of another end bracket of the window rod assembly of FIG. 1.

FIG. 7 is a close up view of a portion of another embodiment of the window a rod assembly.

FIG. 8 is a close up view of a portion of another embodiment of a window rod assembly.

### DETAILED DESCRIPTION

In one aspect, the present invention provides a window rod assembly that uses tension forces to mount the rod in the window opening. No screws or glue are necessary.

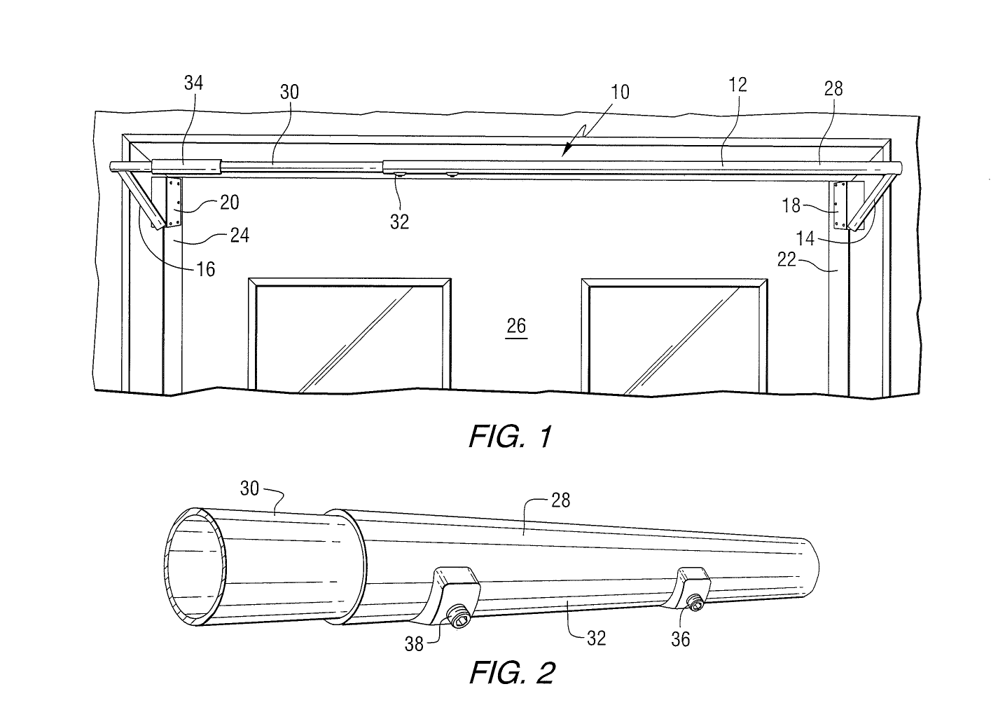

Referring to the drawings, FIG. 1 shows a window rod assembly 10 constructed in accordance with an embodiment of the invention. The window rod assembly is suitable for mounting in a window opening and includes an adjustable support rod 12 extending between two arms 14, 16. Each arm is coupled to an end bracket 18, 20.

The end brackets are configured to be mounted adjacent to opposing interior walls 22, 24 of a window opening 26. The adjustable support rod includes first and second telescoping rod portions 28, 30. One of the first and second telescoping rod portions is configured to slideably into the other telescoping rod portion. A fastening means 32 is provided to fix the relative position of the first and second telescoping rod portions with respect to each other. While the first and second telescoping rod portions 28, 30 have a circular cross-sectional shape in this embodiment, rod portions having other cross-sectional shapes may also be used. A force adjusting assembly 34 (also called a tension adjusting assembly) is positioned in at least one of the support rod portions. When mounted in a casement window opening 26, the force adjusting assembly is used to force the telescoping rod portions apart. Since the telescoping rod portions are connected to the arms that are connected to the end brackets, the end brackets are forced against opposing walls 22, 24 of the window opening. This action secures the position of the end brackets with respect to the walls of the window opening.

FIG. 2 is a close up view of the fastener means 32 for the adjustable support rod of FIG. 1. The first telescoping rod portion 28 has an inner diameter that is slightly larger than the outer diameter of the second telescoping rod portion 30, allowing the second telescoping rod portion is slide within the first telescoping rod portion. Fasteners, which may comprise alien screws 36, 38, pass through the wall of the first telescoping rod portion and make contact with the wall of the second telescoping rod portion. The thickness of the wall of the first telescoping rod portion in the vicinity of the screws is increased to allow for an increase in the engagement length between the screws and the wall of the second telescoping rod portion. With this fastening means, the length of the support rod can be adjusted in a continuous manner. The screws fix the relative position of the telescoping rod portions in a secure manner to withstand axial forces that are applied when the force adjusting assembly is used to force the brackets against the walls of the window opening.

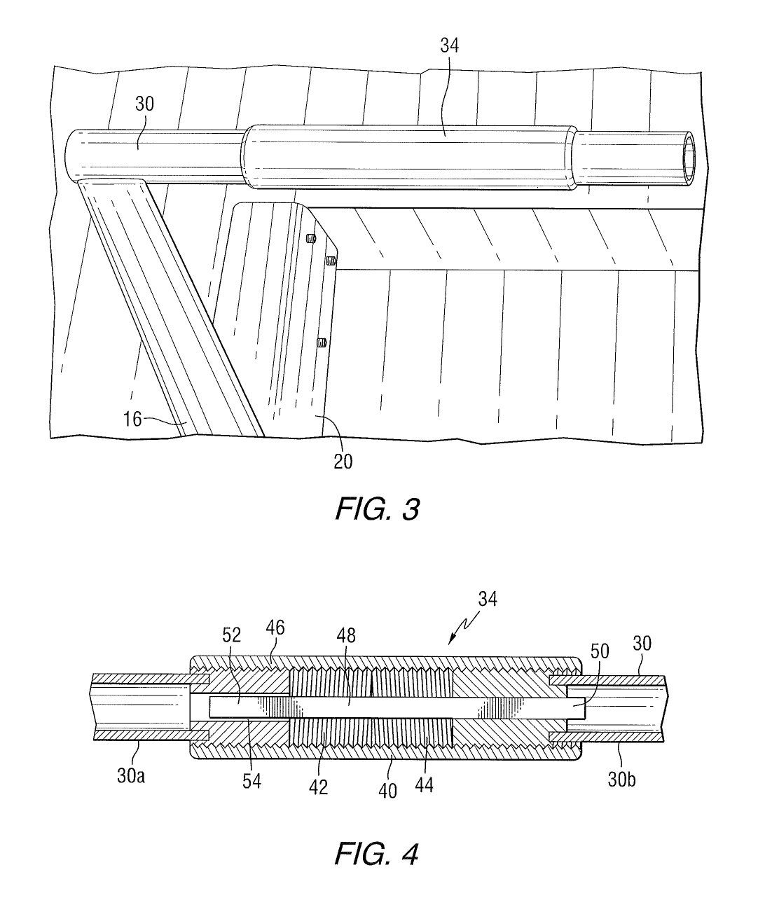

FIG. 3 is a close up view of one telescoping portion 30 of the support rod assembly of FIG. 1. FIG. 3 shows a tension adjusting assembly 34 that is positioned in the first telescoping portion 30.

FIG. 4 is a schematic representation of the tension adjusting assembly 34, also called a tension adjuster. The tension adjusting assembly includes a sleeve 40 having internal threads. The sleeve is positioned over first and second threaded sections 42, 44 of parts 30a and 30b of the telescoping rod portion 30. Threads in the first and second threaded sections are reversed with respect to each other. The internal threads 46 of the sleeve engage the first and second threaded sections of the telescoping rod portion. By rotating the sleeve, the parts of the support rod are forced apart, thereby forcing the end brackets against the opposing interior walls of the window opening as described above. An alignment rod 48 extends between the two threaded sections. One end 50 of the alignment rod is fixed in part 30b, and the other end 52 of the alignment rod is in a slot 54 in part 30a.

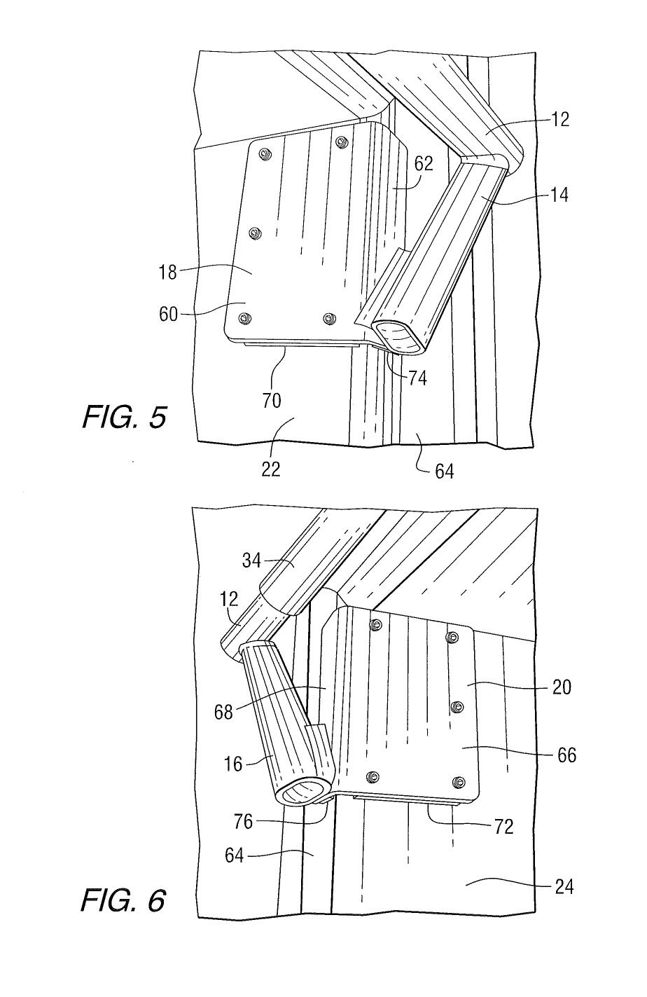

FIG. 5 is a perspective view of the end bracket 18 of the window rod assembly of FIG. 1. End bracket 18 includes a first part 60 and a second part 62. The first part 60 is configured to be positioned adjacent to the interior wall 22 of the opening. The second part 62 is configured to be positioned adjacent a casing 64 or wall adjacent to the window opening.

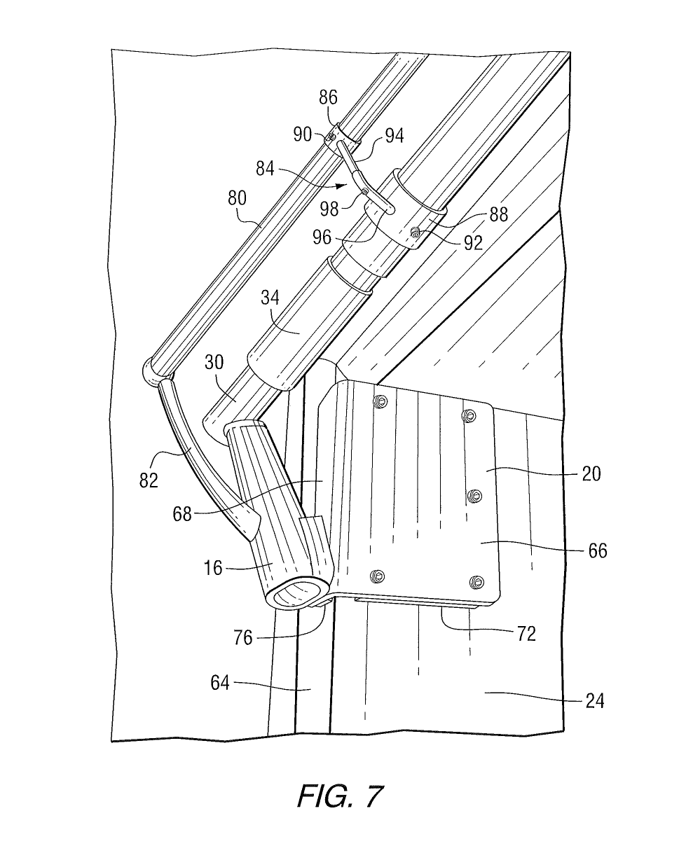

FIG. 6 is a perspective view of the end bracket 20 of the window rod assembly of FIG. 1. End bracket 20 includes a first part 66 and a second part 68. The first part 66 is configured to be positioned adjacent to the interior wall 24 of the opening. The second part 68 is configured to be positioned adjacent a casing 64 or wall adjacent to the window opening.

The second part of each end bracket is configured to be mounted adjacent a casing 64 or wall adjacent to the window opening. This configuration resists twisting forces applied to the bracket due to the weight of the support rod and a curtain mounted on the support rod. Resilient pads 70, 72, which in one example are rubber pads, can be positioned between the first part of the end brackets and the interior walls 22, 24 of the interior window opening. Resilient pads 74, 76, which in one example are rubber pads, can be positioned between the second part of the end brackets and the walls or casing 36 adjacent to the window opening.

The arms are rigidly attached to both the end brackets and the support rod, such that when the support rod is lengthened, the first parts of the brackets are forced into the interior walls of the window opening. For example, the arms can be welded to the end brackets and the support rod. In the illustrated embodiment, the arm extends from the second part of the end brackets in a forward and upward direction. The end brackets can be constructed of two plates positioned in planes that are at a substantially right angle with respect to each other. In FIG. 1, a casing is provided adjacent to the top edge of the casement window opening, and adjacent to the sides on the window opening, and second part of the end brackets is shown to be positioned adjacent to the casing. However, where a casing is not used, the second parts of the end brackets can be positioned adjacent to a wall that is adjacent to the window opening.

To mount the window rod assembly to a window opening, the length of the support rod is adjusted by sliding the telescoping rod portions with respect to each other until the first parts of the brackets are adjacent to the walls of the window opening. In addition, the second parts of the brackets are positioned adjacent to the wall or casing next to the window opening. Then the fastener is tightened to secure the first and second support rod telescoping portions in a fixed position relative to each other. Next, the tension adjusting assembly is adjusted to lengthen the support rod and force the end brackets into the opposing walls of the opening.

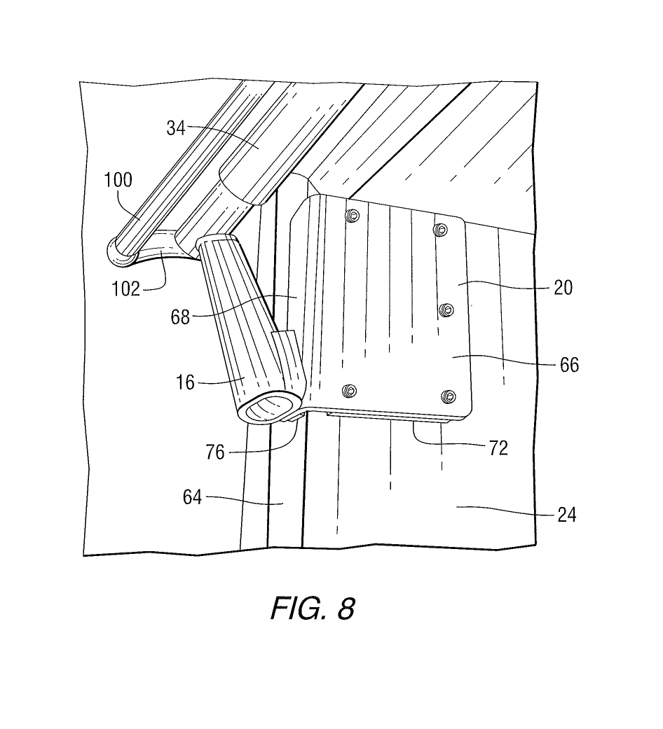

FIG. 7 is a close up view of a portion of a two rod embodiment of a window rod assembly. The embodiment of FIG. 7 includes the elements of FIGS. 1-6 and further includes a second support rod 80. The second support rod is connected to an arm 82. The arm 82 can be connected to arm 16 either in a fixed position, or with a connection that allows for relative movement of arms 16 and 82. Alternatively, arm 82 could be attached directly to the end bracket 20 either in a fixed position, or with a connection that allows for relative movement of arm 82 with respect to the end bracket. In addition, another arm can be positioned adjacent to another end of the support rod 80 and the other arm can be coupled to arm 14 or end bracket 18 in a manner similar to that described for arm 82. An adjustable bracket 84 is shown between support arms 12 and 82. The bracket includes rings 86, 88 that are sized to fit around rods 12 and 80. Locking means, which can be, for example, screws 90 and 92 or other fasteners, are provided to fix the position of the rings with respect to the rods. The bracket further includes two shafts 94, 96 that are connected to the rings and engage each other in a telescoping arrangement. For example, in this embodiment, shaft 94 can be inserted into shaft 96 and the relative positions of the shafts can be secured with a fastener, such as a screw 98. Support rod 80 can be a telescoping rod, similar to support rod 12 and can include a tension adjuster that can be similar to tension adjuster 34. The support rod 80 can further include two telescoping sections and a fastener for maintaining a fixed spatial relationship between the first and second telescoping sections, similar to those described for support rod 12 above.

FIG. 8 is a close up view of a portion of another two rod embodiment of a window rod assembly. The embodiment of FIG. 8 includes the elements of FIGS. 1-6 and further includes a second support rod 100. The second support rod is connected to a bridge 102. The bridge 102 can be connected to arm 16 either in a fixed position, or with a connection that allows for relative movement of arm 16 and bridge 102. In addition, another bridge can be positioned adjacent to another end of the support rod 80 and the other bridge can be coupled to arm 14 or end bracket 18 in a manner similar to that described for bridge 102. An adjustable bracket similar to that shown in FIG. 7 can be positioned between support rods 12 and 100. Support rod 100 can be a telescoping rod, similar to support rod 12 and can include a fastener and tension adjuster that can be similar to fastener 32 and tension adjuster 34.

Using alien key type screws or other fasteners to fix the relative position of the telescoping portions of the support rod, and a tension adjuster, a telescopic rod can be rigidly set inside and near the top of a window casement. In one embodiment, each end of the telescopic rod is connected to an arm that is connected to a bracket with rubber on the inside which grips onto the inside of the window frame. This reduces the possibility of damaging the window opening walls and supplies additional holding power. The telescopic support rod includes a tension adjuster which can be tightened to rigidly fix the rod into its desired position.

The rods, bracket, arms and fasteners may be made from any suitable materials such as metals. The brackets positioned on the top inside of the window unit may have a rubber or soft plastic base which then grips the inside of the window frame. The support rod, which can be positioned outside and above the window, can be initially locked in position using allen screws or the like, then the tension adjuster is used to apply tension into the arms/brackets which hold the rod in place.

The rod can be finished with decorative hardware/finials that are commonly used on window rods. Further, if a person wishes to move the rod, it can be done easily and without damage.

Whereas particular embodiments of this invention have been described above for purposes of illustration, it will be evident to those skilled in the art that numerous variations of the details of the present invention may be made without departing from the invention as set forth in the following claims.

What is claimed is:

1. A window rod assembly comprising:
a support rod extending between first and second arms, wherein the support rod includes first and second rod portions, and the first rod portion is slideably engaged with the second rod portion;
a fastener for maintaining a fixed spatial relationship between the first and second rod portions;
a force adjuster positioned in one of the first and second rod portions;
a first end bracket coupled to the first arm, the first end bracket including a first part configured to be positioned adjacent to a first interior surface of an opening; and
a second end bracket coupled to the second arm, the second end bracket including a first part configured to be positioned adjacent to a second interior surface of the opening.

2. The window rod assembly of claim 1, wherein the force adjuster comprises:
a first threaded section having threads with a first orientation;
a second threaded section having threads with a reverse orientation; and
a sleeve positioned over the threaded sections and having internal thread that engages the threads of the first and second threaded sections such that rotation of the sleeve either forces the threaded sections apart or pulls the threaded sections together.

3. The window rod assembly of claim 1, wherein each of the end brackets further comprises:
a second part configured to contact a wall or casing adjacent to the opening.

4. The window rod assembly of claim 3, further comprising:
a resilient backing material adjacent to each of the first and second parts of each end bracket.

5. The window rod assembly of claim 3, wherein the first and second parts of each end bracket are oriented in planes that are at a right angle with respect to each other.

6. The window rod assembly of claim 1, wherein the fastener comprises:
a screw extending through a wall of the first rod portion and making contact with a wall of the second rod portion to hold the second rod portion in a fixed axial position with respect to the first rod portion.

7. The window rod assembly of claim 1, wherein each of the arms is welded to one of the end brackets.

8. The window rod assembly of claim 1, wherein each of the end brackets comprises:
first and second plates oriented at a right angle with respect to each other, wherein one of the arms is coupled to one of the plates of each end bracket.

9. The window rod assembly of claim 1, further comprising:
a second support rod extending between third and fourth arms, wherein the third arm is connected to the first arm and the fourth arm is connected to the second arm.

10. The window rod assembly of claim 9, wherein the second support rod includes first and second rod portions, and the first rod portion is slideably engaged with the second rod portion, and the window rod assembly further comprises:
a fastener for maintaining a fixed spatial relationship between the first and second rod portions of the second support rod; and
a second force adjuster positioned in one of the first and second rod portions of the second support rod.

11. The window rod assembly of claim 1, further comprising:
a second support rod extending between third and fourth arms, wherein the third arm is connected to the first end bracket and the fourth arm is connected to the second end bracket.

12. The window rod assembly of claim 11, wherein the second support rod includes first and second rod portions, and the first rod portion is slideably engaged with the second rod portion, and the window rod assembly further comprises:
a fastener for maintaining a fixed spatial relationship between the first and second rod portions of the second support rod; and
a second force adjuster positioned in one of the first and second rod portions of the second support rod.

13. The window rod assembly of claim 1, further comprising:
a second support rod extending between first and second bridges, wherein the first bridge is connected to the first arm and the second bridge is connected to the second arm.

14. The window rod assembly of claim 13, wherein the second support rod includes first and second rod portions, and the first rod portion is slideably engaged with the second rod portion, and the window rod assembly further comprises:
a fastener for maintaining a fixed spatial relationship between the first and second rod portions of the second support rod; and
a second force adjuster positioned in one of the first and second rod portions of the second support rod.
